(19) United States
(12) Patent Application Publication
(10) Pub. No.: US 2016/0379264 A1
(43) Pub. Date: Dec. 29, 2016

(54) INCENTIVE OFFER MANAGEMENT SYSTEM

(71) Applicant: PAYPAL, INC., San Jose, CA (US)

(72) Inventors: Carey Kolaja, Montclair, NJ (US); Todd Pinkerton, Arlington, MA (US); Adriana Bello, Sau Paulo (BR)

(21) Appl. No.: 15/190,668

(22) Filed: Jun. 23, 2016

Related U.S. Application Data
(60) Provisional application No. 62/185,245, filed on Jun. 26, 2015.

(51) Int. Cl. G06Q 30/02; G06Q 20/32

(52) U.S. Cl. CPC G06Q 30/0267; G06Q 20/3224

(57) ABSTRACT

Embodiments described herein disclose a mobile device for managing and saving incentive offers within an application executed by the mobile device. A location of the device may be detected. An incentive offer may be displayed on a touch-sensitive display based on the detected location. In response, the user may perform a directional touch input on the display. In one example, the directional touch input is a swipe gesture towards a direction (e.g., right). In response to the swipe gesture, the offer may be associated with the user's account information. A request to use a selected incentive offer is received. The display then displays the offer to be used. Thus, the user is presented with relevant offers based on the location, and may easily save offers of interest in a manner that is consistent with typical gestures used on the touch-sensitive display device of the mobile device.

### CROSS REFERENCE TO RELATED APPLICATIONS

The present application claims priority to and incorporates by reference U.S. Provisional Patent Application Ser. No. 62/185,245, attorney docket #70481.1761PV01 (P3082PRV), filed on Jun. 26, 2015.

### BACKGROUND

Field

The present disclosure generally relates to mobile transactions and more particularly to a system and input interface that interprets user interface gestures for managing incentive offers.

Related Art

More and more consumers are conducting transactions, such as searching for and purchasing, items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment services provider such as, for example, PayPal, Inc. of San Jose, Calif. Such payment services providers can make transactions easier and safer for the parties involved. Purchasing with the assistance of a payment services provider from the convenience of virtually anywhere using a mobile device is one main reason why on-line and mobile purchases are growing very quickly.

Additionally, many consumers may use applications provided by payment services providers to make purchases at traditional, brick-and-mortar establishments. Using these applications may permit the consumer to eliminate the need to carry credit cards, and can provide the user with the ability to manage multiple payment sources, loyalty programs, and other related information. In addition, these and other applications, as well as merchant websites, may provide the user with incentive offers, such as coupons, for frequently visited businesses or for businesses likely to be relevant to the user. However, these incentive offers may be cumbersome to select, store, and manage.

Thus, there is a need for an improved system and method for presenting and allowing a user to manage incentive offers.

### BRIEF DESCRIPTION OF THE FIGURES

FIG. 1 is a flow chart illustrating an embodiment of a method for providing incentive offers to a user and utilizing user interface gestures for managing one or more incentive offers;

FIG. 2a is a front view illustrating an embodiment of a touch-sensitive display device on a payer device displaying a mobile application provided by a payment services provider;

FIG. 2b is a front view illustrating an embodiment of a touch-sensitive display device on a payer device displaying a mobile application provided by a payment services provider with merchant information;

FIG. 2c is a front view illustrating an embodiment of a touch-sensitive display device on a payer device displaying a mobile application provided by a payment services provider with an incentive offer;

FIG. 2d is a front view illustrating an embodiment of a touch-sensitive display device on a payer device displaying a mobile application provided by a payment services provider with a further incentive offer;

FIGS. 2ea-2eb is a front view illustrating an embodiment of a touch-sensitive display device on a payer device displaying a mobile application provided by a payment services provider with an incentive offer and an indication of a directional touch gesture;

FIG. 2f is a front view illustrating an embodiment of a touch-sensitive display device on a payer device displaying a mobile application provided by a payment services provider with an indication of a saved incentive offer;

FIG. 2g is a front view illustrating an embodiment of a touch-sensitive display device on a payer device displaying a mobile application provided by a payment services provider with an incentive offer and an indication of a further directional touch gesture;

FIG. 2h is a front view illustrating an embodiment of a touch-sensitive display device on a payer device displaying a mobile application provided by a payment services provider with an indication of a discarded incentive offer;

FIG. 2i is a front view illustrating an embodiment of a touch-sensitive display device on a payer device displaying a mobile application provided by a payment services provider with an incentive offer and an indication of a further directional touch gesture;

FIG. 2j is a front view illustrating an embodiment of a touch-sensitive display device on a payer device displaying a mobile application provided by a payment services provider with a display allowing a user to share an incentive offer;

FIG. 2k is a front view illustrating an embodiment of a touch-sensitive display device on a payer device displaying a mobile application provided by a payment services provider with an incentive offer and an indication of a further directional touch gesture;

FIG. 2l is a front view illustrating an embodiment of a touch-sensitive display device on a payer device displaying a mobile application provided by a payment services provider and including an input allowing a user to enter notes about an incentive offer;

FIG. 2m is a front view illustrating an embodiment of a touch-sensitive display device on a payer device displaying a mobile application provided by a payment services provider with an incentive offer and touch targets;

FIG. 2n is a front view illustrating an embodiment of a touch-sensitive display device on a payer device displaying a mobile application provided by a payment services provider with one or more offers saved by a user of the payer device;

FIG. 3 is a schematic view illustrating an embodiment of a networked system;

FIG. 4 is a perspective view illustrating an embodiment of a payer device;

FIG. 5 is a perspective view illustrating a further embodiment of a payer device;

FIG. 6 is a schematic view illustrating an embodiment of a computer system; and

FIG. 7 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for managing and saving incentive offers within an application provided by a payment services provider. The application may be executed by a mobile device having location detection sensors, such as GPS location sensors, and a touch-sensitive display device. A location of the mobile device may be detected using the location sensors. An incentive offer may then be displayed on the touch-sensitive display device of the mobile device based on the detected location. In response, the user may perform a directional touch input on the touch-sensitive display device. In one example, the directional touch input is a swipe gesture in a first direction or towards a first location, such as towards a right edge of the touch-sensitive display device. In response to the right swipe gesture, the offer may be saved, or associated, with the user's account information with the payment services provider. In another example, the directional touch input is a swipe gesture in a second direction, such as towards a left edge of the touch-sensitive display device. In response to the left swipe gesture, the offer may be discarded and no longer presented to the user, as well as not presented to the user during subsequent application-use sessions. A request from the user to use a selected incentive offer may then be received using the touch-sensitive display device, and the touch-sensitive display device will then display the selected offer to be used by the user. As such, a user may be presented with relevant offers based on his or her location, and may quickly and easily save those offers that are of interest, discard those offers that are not interesting, and/or provide other instructions for those offers by providing different gestures on the touch-sensitive display device of the mobile device, and may be enabled to subsequently take action on offers without the need for menu selections.

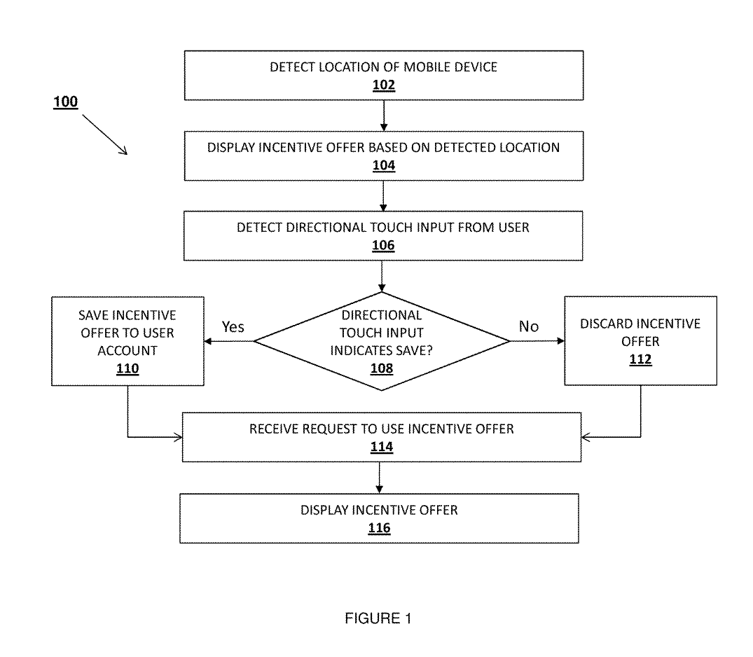

Referring now to FIG. 1, an embodiment of a method 100 for presenting, managing and providing an interface for selecting and storing incentive offers within an application on a mobile device with a touch-sensitive display device is described. In the embodiments and examples discussed below, system functionality is realized by an application provided by a payment services provider that may provide a user wallet functionality that allows the user to save one or more payment instruments or other methods of payment, make payments to online and/or offline (e.g., brick-and-mortar) merchants using those payment instrument(s), transfer money to other users using those payment instrument(s), and/or provide other wallet functionality known in the art. However, the functionality described with respect to the embodiments disclosed herein is not limited to the aforementioned wallet functionality provided by the payment services provider, and instead may be implemented in other applications and uses such as, for example, a web browser, mapping applications, and/or other applications executed by a mobile device having a touch-sensitive display device.

The method 100 begins at block 102 where a location of a mobile device is detected. In one embodiment, the location of the mobile device may be detected by one or more location sensors, such as global positioning satellite (GPS) receivers included in a mobile device. In one embodiment, additional location detection sensors are used to detect the location of the mobile device. For example, the mobile device may utilize Wi-Fi triangulation to estimate the location of the mobile device, or may use information from cellular towers to estimate the location of the mobile device. In one embodiment, information from multiple location sensors may be used to increase the accuracy in determining the location of the mobile device.

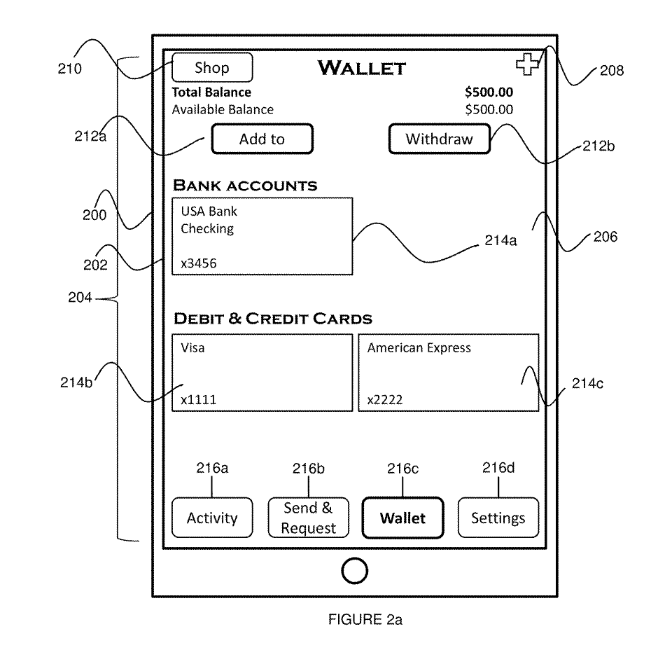

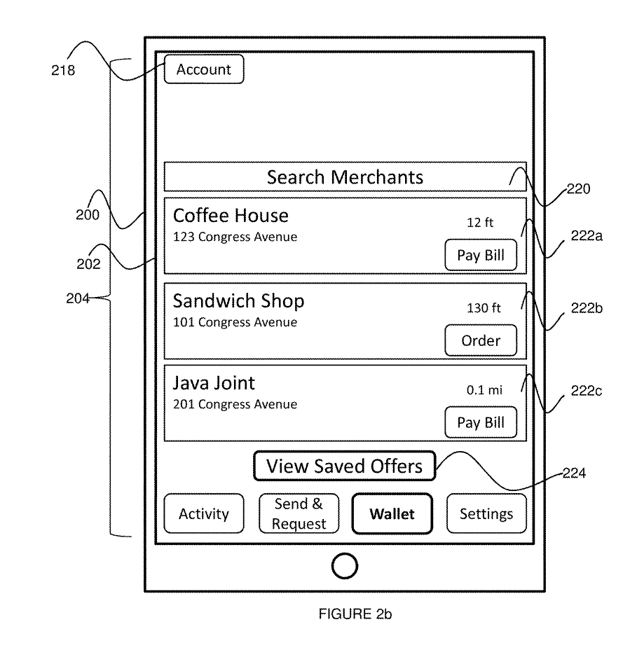

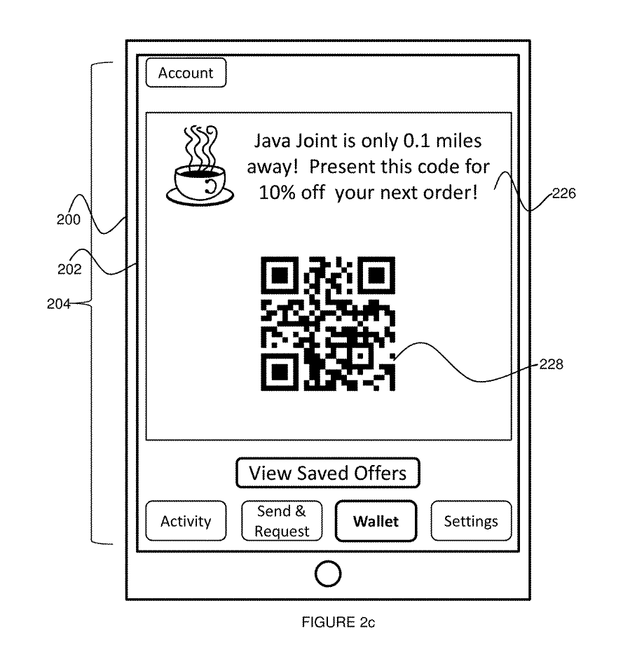

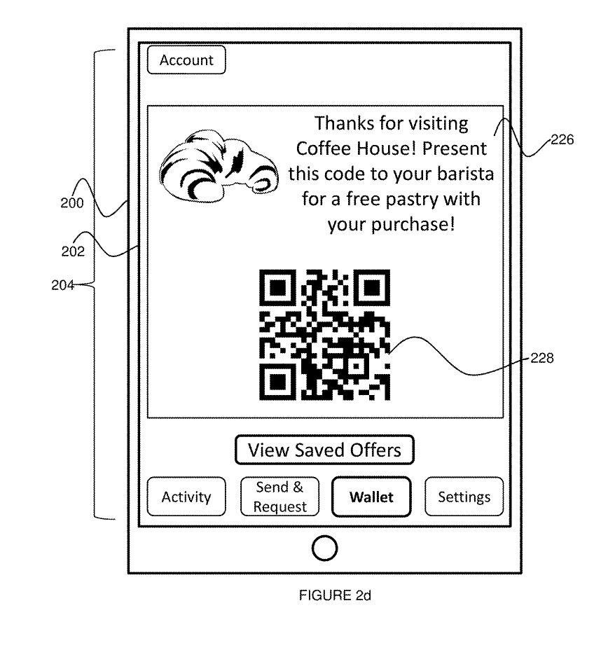

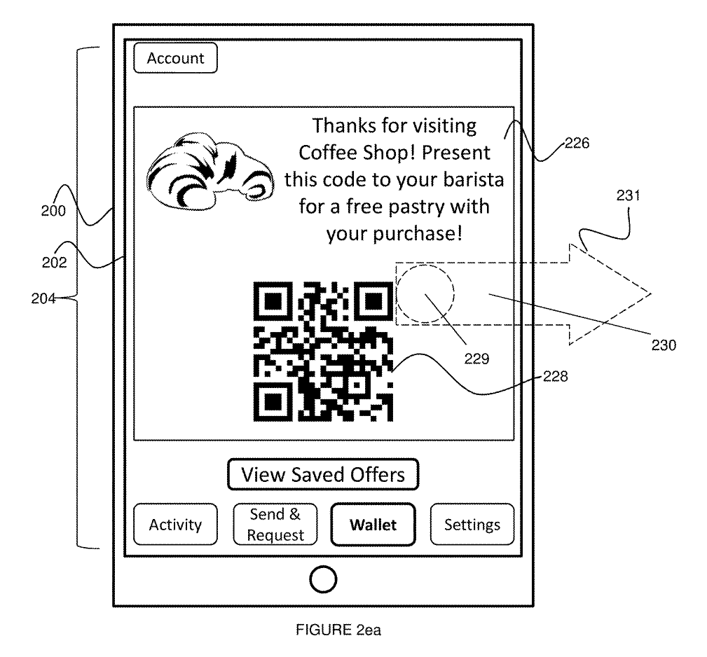

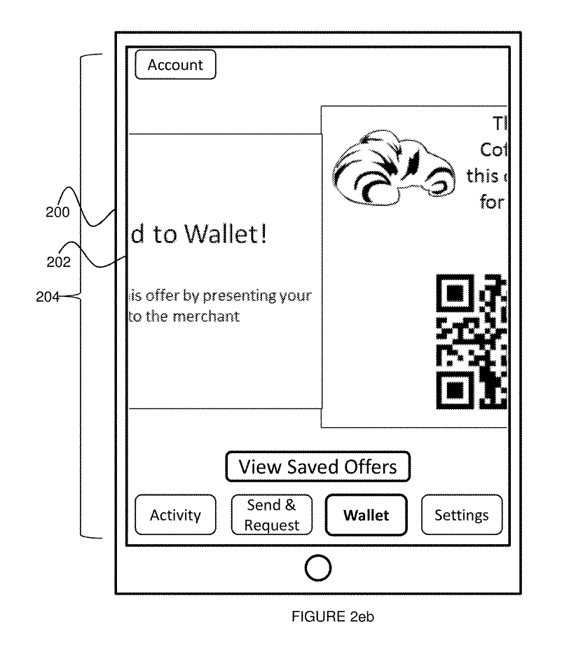

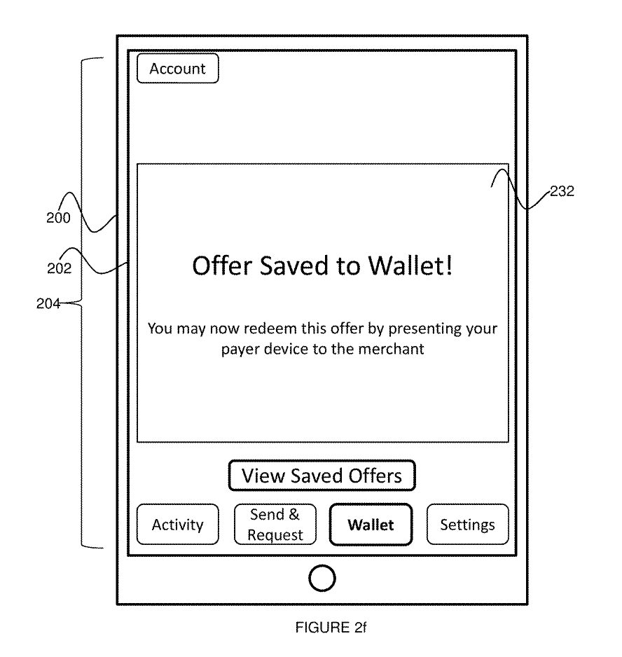

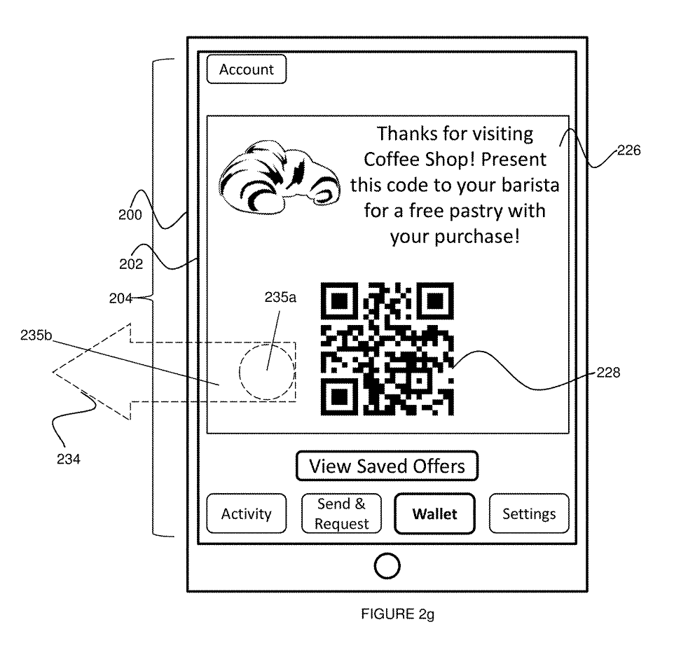

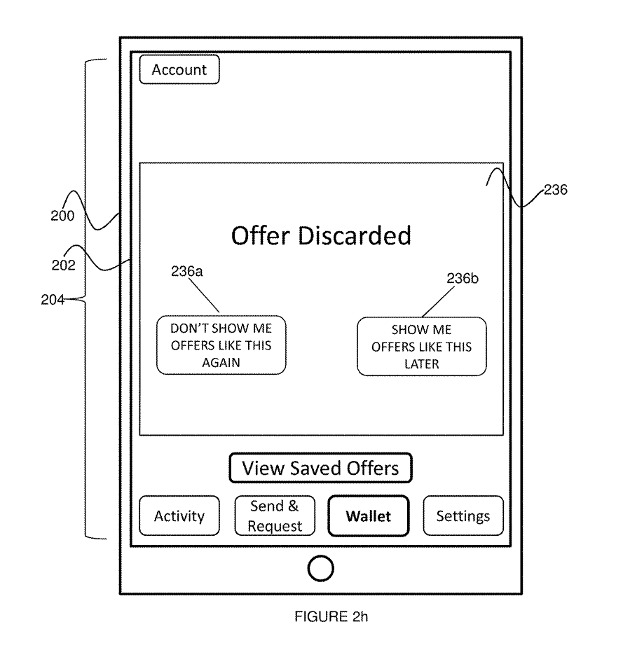

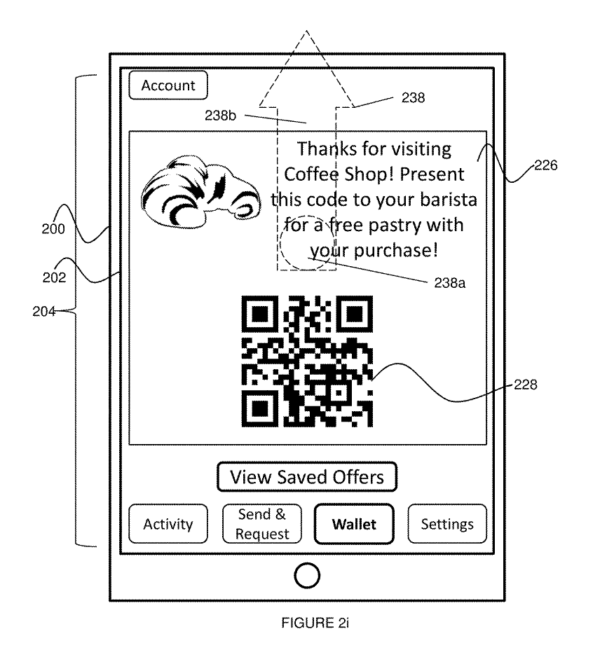

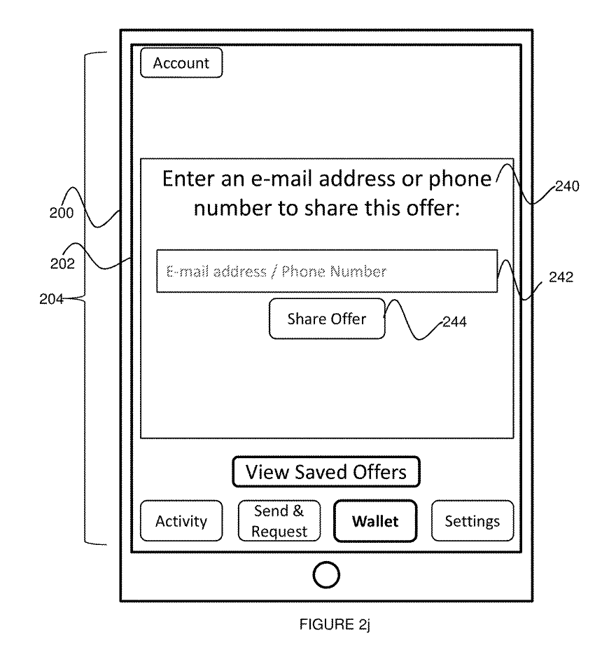

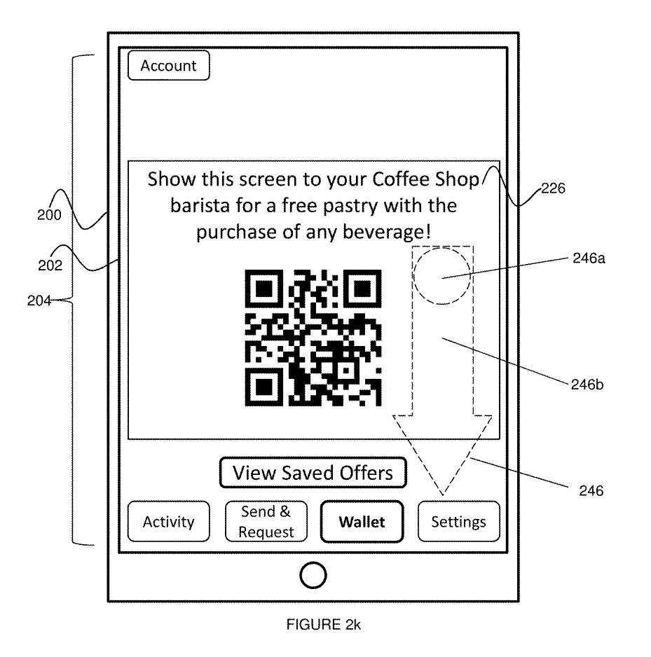

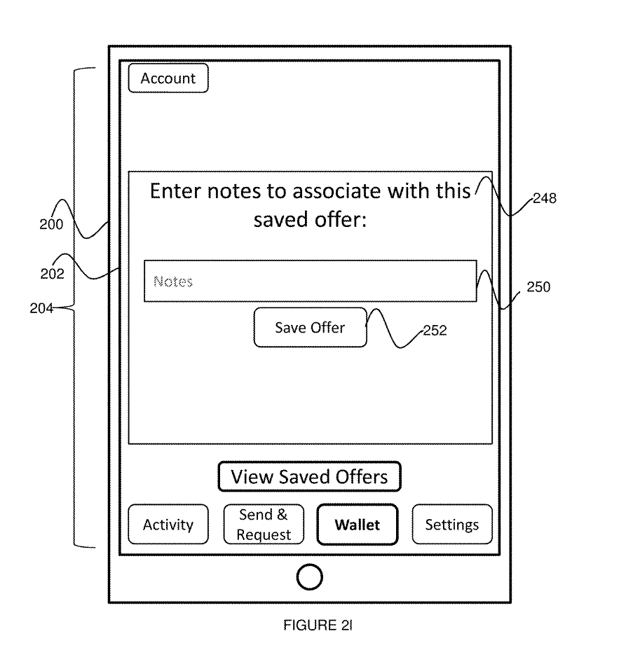

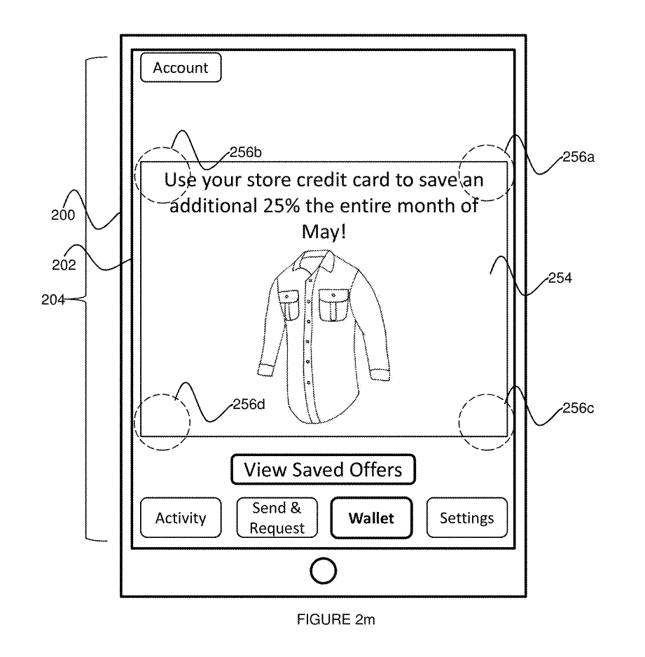

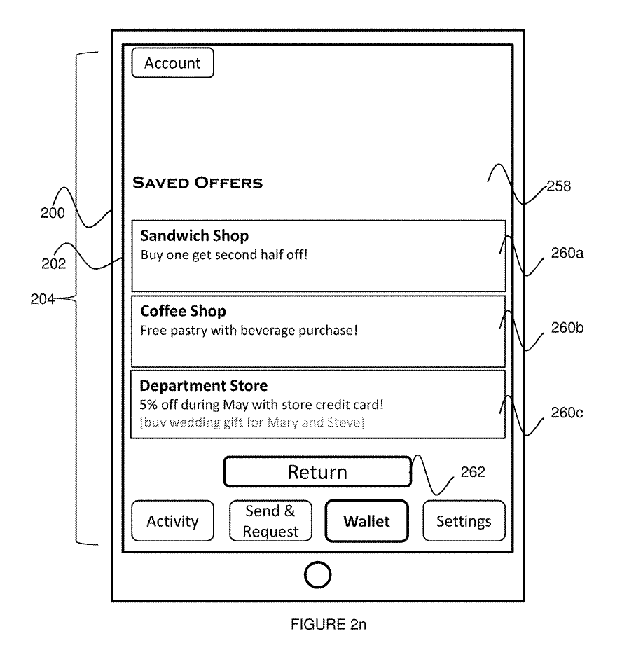

Referring first to FIG. 2a, a payer device 200 includes a display 202 displaying payment application screen 204 that provides wallet functionality 206 of the payment application. As discussed above the payment application may be provided by a payment services provider, such as PayPal Inc. of San Jose, Calif., and the payer associated with the payer device may have a payment account with the payment services provider that allows the payer to access one or more financial accounts for making payments to merchants or other users (e.g., credit financial accounts, banking financial accounts, virtual currency financial accounts, etc). The display 202 is a touch-sensitive or gesture-detecting display device, and may include multi-touch display device functionality that is capable of detecting multiple inputs at once from a user. The wallet functionality 206 of the payment application provides various functions, just a few of which are illustrated in FIG. 2a. For example, the wallet functionality 206 provides the current balance of the user's account with the payment services provider (e.g., $500 in the illustrated embodiment), and further provides a button 212a to allow the user to add funds to his or her account with the payment services provider (e.g., via a transfer from a financial account), and a button 212b to allow the user to withdraw funds from the account with the payment services provider (e.g., to a financial account or other user). Additionally, the wallet functionality 206 provides the financial accounts associated with the user's account information, such as a bank account 214a, and credit cards 214b and 214c. The wallet functionality 206 also includes a button 208 to allow the user to add a new account or funding source, such as a credit card, debit card, store loyalty card, gift card, bank account, virtual currency account, or other financial account to the user's account with the payment services provider. The wallet functionality 206 also provides a “shop” button 210 that may allow the user to purchase items from a merchant with the funds in the user's account with the payment services provider. As shown in FIG. 2a, the payment application provided by the payment services provider may include other functionality accessible by buttons 216a-216d. For example, button 216a may allow the user to view his or her activity with the payment services provider and/or financial accounts, button 216b may allow the user to send or request money from another user, button 216c (which is indicated as selected in FIG. 2a) provides access to the wallet functionality described above, and button 216d may allow the user to view and edit his or her settings or account information with the payment services provider.

Referring now to FIG. 2b, the user may select the “shop” button 210 displayed in FIG. 2a, and may be presented with the shopping display illustrated in FIG. 2b. The shopping display of FIG. 2b includes a button 218 with the label “account”, which may be selected by the user to return the user to the payment application screen 204 illustrated in FIG. 2a. Further, the shopping display of FIG. 2b includes a search field 220 which permits a user to enter a search query and cause the payment application to return relevant merchants or other results matching that query. The display of FIG. 2b also includes a list of one or more merchants, which may be returned based on the detected location of the payer device. For example, a merchant identifier 222a (the “Coffee House”) may be returned in response to an associated merchant being within 12 feet of the payer device 200, whereas merchant identifier 222b may be returned in response to an associated merchant being within 130 feet of the payer device 200, and merchant identifier 222c (the “Java Joint”) may be returned in response to an associated merchant being within 0.1 miles of the payer device 200. As shown in FIG. 2b, the merchant identifiers 222a-222c may be selectable (or include selectable features) that allow a user to pay a bill using the payment application, allow the user to order items using the payment application, and/or allow the user to perform a variety of other payment functionality using the payment application. The shopping display of FIG. 2b also includes a button 224 to allow a user to view incentive offers previously stored in association with the user's account, discussed in further detail below.

The method 100 then proceeds to block 104 where an incentive offer is displayed based at least on the location of the payer device. The incentive offer may be retrieved over a network from the payment services provider which provides the payment application to the user, a merchant device of a merchant that is associated with the location of the payer device, a third party incentive offer provider device, and/or other entities known in the art. In one embodiment, the payment services provider device, merchant device, or third party incentive offer device may store multiple offers to be presented to users of the payment application.

Referring now to FIG. 2c, in one embodiment, the offer that is displayed to the user based on the location of their payer device may be an incentive offer for a merchant that competes with a similar merchant that is closer to the current location of the payer device. With reference to FIG. 2b, recall that the distance from the payer device to the “Coffee House” was 12 feet, while the distance from the payer device to the “Java Joint” was 0.1 miles. Thus, in one embodiment, the Java Joint may cooperate with the payment services provider or other provider of incentive offers, to present an incentive offer to the user of the payer device that entices the user to visit the Java Joint instead of the Coffee House (which is presumably at or near the user's current location). In one embodiment, the incentive offer 226 displayed to the user of the payer device includes text describing the offer, and may further include a barcode 228, such as a one-dimensional or two-dimensional (also known as a quick response or “QR”) barcode. For example, in the illustrated embodiment, the incentive offer informs the user how far away they are from Java Joint, as well as that the incentive offer provides 10% off their purchase from Java Joint. In some embodiments, the incentive offer may include a time-based incentive that limits the use of the incentive offer to a particular time period. For example, the incentive offer 226 may be valid for 1 hour, and that time period may be indicated to the user on the incentive offer 226.

Referring now to FIG. 2d, in one embodiment, the incentive offer displayed to the user that is based on the location of the payer device may be an offer for the merchant that is closest to the current location of the payer device. For example, in FIG. 2d and again with reference to FIG. 2b, an incentive offer corresponding to the Coffee House is presented in the payment application screen 204 on the display 202 of payer device 200. As shown in FIG. 2d, the incentive offer 226 for the Coffee House has text describing the offer, and a barcode 228.

The method 100 then proceeds to block 106, where a directional touch input from the user of the payer device is detected. In one embodiment, the directional touch input is detected using the touch-sensitive display device 202 of payer device 200. In one embodiment, the directional touch input is a swipe input towards a particular location or in a particular direction (e.g., left, right, up, down, diagonally, etc.). In other embodiments, rather than a directional touch input, other gestures known in the art may be detected using a gesture-sensitive or detecting display device of the payer device 200. In one embodiment, the payment services provider responsible for payment application 200 may choose to associate a swipe input towards a particular direction and/or other gestures with an action. In other embodiments, the user may define or designate particular swipe inputs and/or gestures with particular actions.

For example, a swipe input towards the right edge of the touch-sensitive display device 202 may result in a displayed incentive offer being saved to a user's account with the payment services provider. In another example, a swipe input towards the left edge of the touch-sensitive display device 202 may result in a displayed incentive offer to be discarded (e.g., as the user may not be interested in the particular offer) and, in some situations, marked, such that that offer is not presented to the user again or for some designated time period. In another example, a swipe input in a downward direction towards a bottom edge of the touch-sensitive display device 202 may result in a displayed incentive offer being saved and associated with one or more notes that are subsequently entered by the user. In another example, a swipe input in an upward direction towards a top edge of the touch-sensitive display device 202 may result in a displayed incentive offer being shared with a recipient subsequently chosen by the user. Other directional touch inputs are possible as well. For example, directional touch inputs towards diagonal locations (e.g., upper right corner of the touch-sensitive display device 202, upper left corner of the touch-sensitive display device 202) may be associated with further actions with respect to the displayed incentive offer. One of skill in the art in possession of the present disclosure will recognize that different combinations of swipe inputs and/or gestures may be utilized to define specific actions to perform with regard to the incentive offer being displayed. For example, the upward swipe input discussed above may be combined with a double tap or hand signal (e.g., holding up two fingers that may be detected by a camera on the payer device) in order to automatically share the incentive offer with particular recipients that were predefined by the user (e.g., prior to the inventive offer being displayed on the payer device 200). Thus, the examples of touch inputs discussed below should not be interpreted as limiting, as a wide variety of touch inputs and/or gestures may be provided and combined to define any of a variety of actions that may be performed with respect to the displayed incentive offer.

Referring now to FIG. 2ea, a directional touch input 230 corresponding to a swipe input towards the right edge of the touch-sensitive display device 202 is depicted. As one example, the user may touch the touch-sensitive display device 202 (as indicated by element 229) and drag his or her finger across the screen the touch-sensitive display device 202 (as indicated by element 230) to perform the directional touch input 231 illustrated in FIG. 2e. In another embodiment, a stylus may be used to provide the directional touch input 231 substantially as discussed above. Referring now to FIG. 2f, in response to the detection of the directional touch input 231 of FIG. 2e, the display of the payer device 200 may change to provide a notification 232 to the user that the previously-displayed incentive offer was saved to their wallet of their payment services provider application and that the user may present the payer device 200 or the saved offer to a merchant for redemption. For example, as illustrated in FIGS. 2ea, 2eb, and 2f, the screen that displays the incentive offer 226 may be graphically “moved” in the direction of the directional touch input 231 (e.g., to the right) such that the screen that displays the notification 232 is graphically “revealed” or “moved” onto the screen. In some embodiments, the notification 232 may only be displayed for a relatively short time period, and then replaced with a new incentive offer.

In one embodiment, the directional touch input 231 causes the payer device 200 or the application provided by the payment services provider to associate the incentive offer with account information of the user (e.g., in a database on the payer device 200, in a database of the payment services provider device, etc.). Further, an indication that the particular offer was saved may be transmitted to the payment services provider, which may use the information to tailor future incentive offers to the user or other users. In some embodiments, the use of the incentive offer may require that the incentive offer be saved to the payment application using the directional touch input 231 discussed above, and thus the indication that the particular offer was saved may include an instruction to present the payer device and/or saved offer to the merchant associated with that offer in order to redeem the offer. In some embodiments, the indication that the particular offer was saved may further identify the merchant such as, for example, by providing directions to that merchant (e.g., by providing directions to Java Joint, discussed above, when the user was presented the incentive offer at the Coffee House).

Referring now to FIG. 2g, a directional touch input 234 corresponding to a swipe input towards the left is depicted. As with the above example, the user may touch the screen of the touch-sensitive display device 202 (as indicated by element 235a) and drag his or her finger across the screen of the touch-sensitive display device 202 (as indicated by element 235b) to perform the directional touch input 234. Referring now to FIG. 2h, in response to the detection of the directional touch input 234 of FIG. 2g, the display of the payer device 200 may change to include a notification 236 to the user that the previously-displayed incentive offer was discarded. For example, the screen that displays the incentive offer 226 may be graphically “moved” in the direction of the directional touch input 234 (e.g., to the left) such that the screen that displays the notification 236 is graphically “revealed” or “moved” onto the screen (e.g., similarly as illustrated in FIGS. 2ea, 2eb, and 2f). In some embodiments, the notification 236 may only be displayed for a relatively short time period, and then replaced with a new incentive offer.

In some embodiments, the discarded incentive offer may not be presented to the user in the future. In some embodiments, the user may determine whether the offer that was discarded is presented to them in the future. For example, the notification 236 may include a button 236a that the user may select to indicate that they would no longer like to see that offer (or offers like that offer) again, such as in cases when the offer was for an item that the user dislikes. The notification 236 may also include a button 236b that the user may select to indicate that they would like to see that offer (or offers like that offer) in the future, such as in cases when the offer was for an item that the user likes but was not interested in taking advantage of at that time. Further, the selections of the buttons 236a or 236b, or the indication that the particular offer was discarded, may be transmitted to the payment services provider for use in tailoring future incentive offers to the user or other users.

Referring now to FIG. 2i, a directional touch input 238 corresponding to a swipe input upwards is depicted. As with the above example, the user may touch the screen of the touch-sensitive display device 202 (as indicated by element 238a) and drag his or her finger across the screen of the touch-sensitive display device 202 (as indicated by element 238b) to perform the directional touch input 238. Referring now to FIG. 2j, in response to the detection of the directional touch input 238 of FIG. 2i, the display of the payer device 200 may change to include a share screen 240 or gift screen, which allows the user to share the offer with another user. For example, the screen that displays the incentive offer 226 may be graphically “moved” in the direction of the directional touch input 238 (e.g., up) such that the share screen 240 is graphically “revealed” or “moved” onto the screen (e.g., similarly as illustrated in FIGS. 2ea, 2eb, and 2f).

In the illustrated embodiment, the share screen 240 includes a text input field 242 which allows the user to enter in an e-mail address, phone number, or other identifier of a second user to share the offer with, along with a button 244 to confirm the sharing. However, in other embodiments, the text input field 242 may be automatically filled with one or more second users, or else a touch input or gesture may be provided by the user to indicate one or more users the offer should be shared with, as discussed above. In response to the sharing, the offer may be transmitted to the second user using the identifier. Further, an indication that the particular offer was shared may be transmitted to the payment services provider, which may use the information to tailor future incentive offers to the second user or other users. Following the sharing of the offer, the share screen 240 may be replaced with a new incentive offer.

Referring now to FIG. 2k, a directional touch input 246 corresponding to a swipe input downwards depicted. As with the above example, the user may touch the screen of the touch-sensitive display device 202 (as indicated by element 246a) and drag his or her finger across the screen of the touch-sensitive display device 202 (as indicated by element 246b) to perform the directional touch input 246. Referring now to FIG. 2l, in response to the detection of the directional touch input 246 of FIG. 2k, the display of the payer device 200 may change to include a notes screen 248, which allows the user to enter notes regarding the offer. For example, the screen that displays the incentive offer 226 may be graphically “moved” in the direction of the directional touch input 246 (e.g., down) such that the notes screen 248 is graphically “revealed” or “moved” onto the screen (e.g., similarly as illustrated in FIGS. 2ea, 2eb, and 2f).

The notes screen 248 may include a text input field 250, which permits the user to enter in text to be associated with the incentive offer, and a button 252 to save the offer with the associated text. As described above, the button 252 may cause the payer device 200 or the application provided by the payment services provider to associate the incentive offer and the text with account information of the user. However, in other embodiments, the notes screen 248 may activate an audio recording device in the payer device 200 such that the user may provide audio notes that are then associated with the incentive offers. In yet other embodiments, the notes screen 248 may activate a video recording device in the payer device 200 such that the user may provide video notes that are then associated with the incentive offers. Furthermore, the notes screen 248 may be combined with other screens that are provided in response to other directional touch input. For example, the directional touch input 246 (e.g., the swipe input downward) may be provided on the share screen 240 illustrated in FIG. 2j in order to provide such text, audio, and/or video notes on an incentive offer that is shared with one or more other users. Following the provisioning of notes for the offer, the share screen 240 may be replaced with a new incentive offer.

Referring now to FIG. 2m, in one embodiment, instead of or in addition to directional touch inputs, the application provided by the payment services provider may provide touch targets in particular locations on the touch-sensitive display device 202 that correspond to the above actions (e.g., save, discard, share/gift, save with notes, and/or combinations thereof). Thus, in one example, a user may activate touch target 256a to save a displayed incentive offer, or may activate touch target 256b to discard a displayed incentive offer. Similarly, the user may activate touch target 256c to save a displayed incentive offer with notes, or may activate touch target 256d to share a displayed incentive offer. The selected touch target may be activated when the user presses his or her finger on the area of the touch target on the touch-sensitive display device 202. In other embodiments, the touch targets illustrated in FIG. 2m may be utilized to provide the other touch inputs and/or gestures discussed above (e.g., in addition to and/or in combination with the directional touch inputs) that allow for the different actions discussed above (e.g., swipe input up to access the share screen 226, with the different touch targets indicating different users or different user groups with which to share the offer). In one embodiment, different types of touch inputs may be utilized to activate the touch targets (e.g., a press-and-hold gesture, a double “tap”, a triple “tap”, a “pinch”, and/or other touch inputs known in the art).

The method 100 then proceeds to block 108, where it is determined whether the directional touch input indicates that the incentive offer is to be saved. For example, as described above, a swipe input towards the right and a swipe input downward both correspond to saving the incentive offer, with the swipe input downward also corresponding to a user adding notes for a particular incentive offer. Thus, if the directional touch input indicates that the incentive offer is to be saved, method 100 proceeds to block 110, where the incentive offer is saved to the user's account. In some embodiments, an indication to save the incentive offer may be transmitted over a network to the payment services provider, or may be transmitted over a network to a third party or a merchant associated with the incentive offer. Further, in some embodiments, the incentive offer may be saved on the payer device 200.

As also described above, a swipe input towards the left may correspond to discarding the offer, while the swipe input upward may corresponding to a user sharing the offer with a second user (which may result in the offer being “discarded” for the user and sent to the second user, or which may result in the offer being saved for the user, as discussed above, as well as being shared with the second user). Thus, if the directional touch input indicates that the incentive offer is to be discarded, method 100 proceeds to block 112, where the incentive offer is discarded. In one embodiment, an indication that the incentive offer is discarded is saved to the user's account, or may be transmitted over a network to the payment services provider, third party, or merchant associated with the incentive offer. As discussed above, the discarded offer may be associated with instructions related to how that offer and/or similar offers should be presented to the user in the future, and such instructions may be saved in the payer device, payment services provider device, merchant device, third party device, and/or other system provider device

The method 100 then proceeds to block 114, where a request is received to use a selected incentive offer. In one embodiment, the request is received using the touch-sensitive display device. For example, with reference again to FIG. 2b, a user may press or select the “View Saved Offers” button 224 displayed on the screen 202 to view a list of the incentive offers saved by way of the directional touch inputs discussed above. Referring now to FIG. 2n, the payer device 200 may display a “Saved Offers” screen 258, which includes a plurality of saved incentive offers 260a-260c. Each saved incentive offer 260a-260c may include the name of the establishment corresponding to the incentive offer, a short description of the incentive offer, notes associated with that offer by the user (as discussed above) and/or a variety of other offer information known in the art. Incentive offer 260c includes such a display of a short note entered by the user and associated with the incentive offer (e.g., “buy wedding gift for Mary and Steve”). Each saved incentive offer 260a-260c that is displayed on the saved offers screen 258 may be retrieved over a network (e.g., from the payment services provider device) or retrieved from storage on payer device 200.

After the user selects a saved incentive offer 260a-260c, for example, the method 100 then proceeds to block 116, where the selected incentive offer is displayed on the display of the payer device 200. The incentive offer may then be used at the merchant or other establishment associated with the incentive offer (e.g., by presenting the QR codes illustrated in the offers above to a QR code reader at the merchant).

In other embodiments, offers that were saved using the directional touch inputs discussed above may be automatically displayed on the payer device for presentment to a merchant, or automatically presented to the merchant without display on the payer device at all. For example, a payer device 200 that is associated with the payment account for which the offers were saved may determine that it is at a location that is associated with a merchant for which offers have been saved (e.g., using a location determination device in the payer device 200, via communication between the payer device 200 and a merchant device, via communication between the payer device and the payment services provider device). In one example, in response to the determination that the payer device 200 is at a location associated with a merchant for which offers have been saved, those offers may be displayed on the payer device 200 (e.g., in a popup window, on the application, etc.) such that the user may select a desired offer for presentment to the merchant. In another example, in response to the determination that the payer device 200 is at a location associated with a merchant for which offers have been saved, the payer device may automatically communicate each offer that was saved for that merchant to that merchant, and that merchant may subsequently redeem any appropriate offers saved by the user.

In one embodiment, after the user has viewed a displayed incentive offer with reference to block 104 of method 100 and provided a directional touch input or other gesture to cause one of the actions discussed above to be performed, the user may be presented with additional offers (e.g., a user may provide a directional touch input to save a first incentive offer, and subsequently be presented with a second incentive offer that the user may provide a directional touch input to discard, and subsequently be presented with further incentive offers that may be saved, discarded, or shared as discussed above). Thus, the user can be presented with multiple successive incentive offers, and for each offer may provide the quick and easy user interface gestures discussed above in order to save, discard, share, and/or otherwise manage the incentive offers according to the user's interests. Thus, at a particular location, a merchant may provide a plurality of offers to a user in such a manner, and the user may quickly and easily “swipe” through those offers to save the offers they are interested in, discard the offers they are not interested in, share the offers they think others will be interested in, etc.

However, the offers need not be specific to the current location of the user, and instead the user may “swipe” through different categories of offers of interest to the user. In an embodiment, the application on the payer device may allow the user to indicate they would like to be presented with offers from merchants of a particular type, offers for products of a particular type, offers for a particular location (which they are not currently at), and/or other offer features known in the art. For example, a user may indicate that they would like to be presented with offers from Italian restaurants, and then “swipe” through offers from different Italian restaurant merchants. In another example, a user may indicate that they would like to be presented with offers for bicycles, and then “swipe” through offers from different bicycle merchants. In another example, a user may indicate that they would like to be presented with offers for at a location which they will be traveling to in the future, and then “swipe” through offers from different merchants in that location. In addition, combinations of such features may be utilized (e.g., a user may ask to view offers from Italian restaurants at a location that they are planning on visiting in the future, and then “swipe” through offers from different Italian restaurant merchants in that location).

In one embodiment, the incentive offer displayed as described with reference to block 104 of method 100 is an incentive offer that is saved in association with the user's account with the payment services provider. In some embodiments, when the user is within a predetermined distance of a location of the merchant associated with an incentive offer (e.g., a merchant that accepts that incentive offer), or traveling in a direction towards a location of the merchant associated with the incentive offer, the application provided by the payment services provider may present a previously-saved incentive offer to the user (e.g., in a “pop-up” window, a lock-screen notification, via an automatically launching payment application, etc.), so as to remind the user of the incentive offer when it is particularly relevant or likely to become relevant ((i.e., at a time when the user will be able to easily use it because they are close to the merchant or traveling in the direction of the merchant). In some embodiments, the user may then use one of the directional touch inputs discussed above to maintain the offer in his or her account, discard the offer, share the offer, etc.

In one embodiment, information regarding which incentive offers have been saved, discarded, shared, and/or had notes added to them, may be used for other purposes. For example, in one embodiment, the information regarding the incentive offers that have been saved may be used in the wallet portion of the application to recommend other merchants to the user that they may be interested in, or recommend certain products or services to the user that they may be interested in. The use of such information may not be limited to the application provided by the payment services provider executing on the mobile device described above, and instead may be used to present relevant information, for example, on websites using a toolbar provided by the payment services provider in a web browser.

Thus, systems and methods have been described that provide for the selection and storage of (as well as other actions related to) incentive offers. The systems and methods may present a plurality of offers to a user based on the users location, a selected location, and/or a selected offer category, and the user may quickly and easily select and store, discard, share, and/or add notes to those offers. When a user is subsequently in a location associated with a merchant that accepts any stored offer, the user may retrieve that offer or have that offers automatically presented to them, for presentment to a merchant that accepts that offer. As such, the selection, storage, and use of offers is greatly simplified, thus increasing the use of such offers, which provides benefits to both the user and the merchant providing the offer.

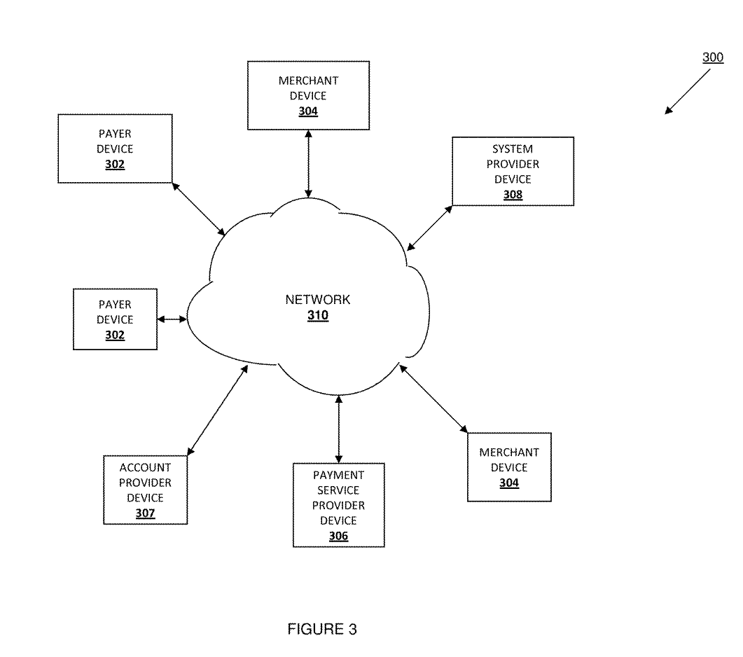

Referring now to FIG. 3, an embodiment of a network-based system 300 for implementing one or more processes described herein is illustrated. As shown, network-based system 300 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 3 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 300 illustrated in FIG. 3 includes a plurality of payer devices 302, a plurality of merchant devices 304, a payment services provider device 306, an account provider device 307, and/or a system provider device 308, in communication over a network 310. Any of the payer devices 302 may be the payer device 200 operated by the users, discussed above. The merchant devices 304 may be the merchant devices discussed above and may be operated by the merchants discussed above. The payment services provider device 306 may be the payment services provider devices discussed above and may be operated by a payment services provider such as, for example, PayPal Inc. of San Jose, Calif. The account provider devices 307 may be the account provider devices discussed above and may be operated by the account providers discussed above such as, for example, credit card account providers, bank account providers, savings account providers, and a variety of other account providers known in the art. The system provider device 308 may be the system provider devices discussed above and may be operated by the system providers discussed above.

The payer devices 302, merchant devices 304, payment services provider device 306, account provider device 308, and/or system provider device 308 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 300, and/or accessible over the network 310.

The network 310 may be implemented as a single network or a combination of multiple networks. For example, in various embodiments, the network 310 may include the Internet and/or one or more intranets, landline networks, wireless networks, and/or other appropriate types of networks.

The payer device 302 may be implemented using any appropriate combination of hardware and/or software configured for wired and/or wireless communication over network 310. For example, in one embodiment, the payer device 302 may be implemented as a personal computer of a user in communication with the Internet. In other embodiments, the payer device 302 may be a smart phone, personal digital assistant (PDA), laptop computer, and/or other types of computing devices.

The payer device 302 may include one or more browser applications which may be used, for example, to provide a convenient interface to permit the payer to browse information available over the network 310. For example, in one embodiment, the browser application may be implemented as a web browser configured to view information available over the Internet.

The payer device 302 may also include one or more toolbar applications which may be used, for example, to provide user-side processing for performing desired tasks in response to operations selected by the payer. In one embodiment, the toolbar application may display a user interface in connection with the browser application.

The payer device 302 may further include other applications as may be desired in particular embodiments to provide desired features to the payer device 302. In particular, the other applications may include a payment application for payments assisted by a payment services provider through the payment services provider device 306. The other applications may also include security applications for implementing user-side security features, programmatic user applications for interfacing with appropriate application programming interfaces (APIs) over the network 310, or other types of applications. Email and/or text applications may also be included, which allow the payer to send and receive emails and/or text messages through the network 310. The payer device 302 includes one or more user and/or device identifiers which may be implemented, for example, as operating system registry entries, cookies associated with the browser application, identifiers associated with hardware of the payer device 302, or other appropriate identifiers, such as a phone number. In one embodiment, the user identifier may be used by the payment services provider device 306 and/or account provider device 307 to associate the user with a particular account as further described herein.

The merchant device 304 may be maintained, for example, by a conventional or on-line merchant, conventional or digital goods seller, individual seller, and/or application developer offering various products and/or services in exchange for payment to be received conventionally or over the network 310. In this regard, the merchant device 304 may include a database identifying available products and/or services (e.g., collectively referred to as items) which may be made available for viewing and purchase by the payer.

The merchant device 304 also includes a checkout application which may be configured to facilitate the purchase by the payer of items. The checkout application may be configured to accept payment information from the user through the payer device 302, the account provider through the account provider device 307, and/or from the payment services provider through the payment services provider device 306 over the network 310.

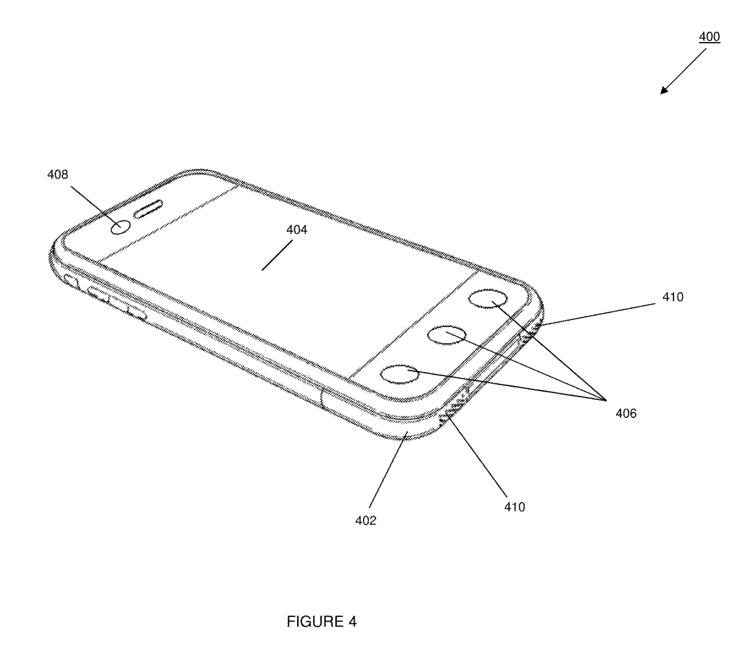

Referring now to FIG. 4, an embodiment of a payer device 400 is illustrated. The payer device 400 may be the payer devices 200 and/or 302. The payer device 400 includes a chassis 402 having a display 404 and an input device including the display 404 and a plurality of input buttons 406. The payer device 400 further includes a camera 408 and one or more audio input/output devices (e.g., microphones, speakers) 410. One of skill in the art will recognize that the payer device 400 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

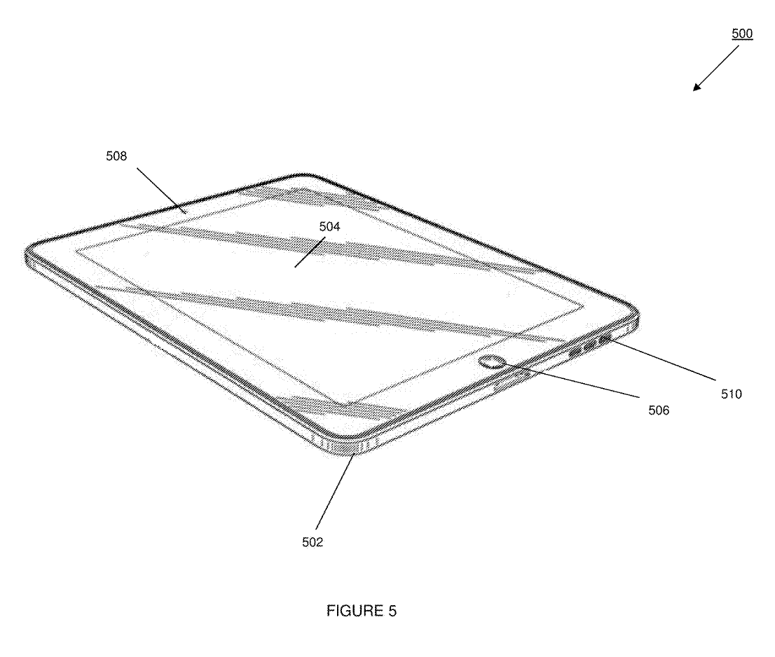

Referring now to FIG. 5, a further embodiment of a payer device 500 is illustrated. The payer device 400 may be the payer devices 200 and/or 302. The payer device 500 includes a chassis 502 having a display 504 and an input device including the display 504. The payer device 500 may also include an input button 406 and one or more audio input/output device 508 (e.g. microphones, speakers). One of skill in the art will recognize that the payer device 500 is a portable or mobile table device including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

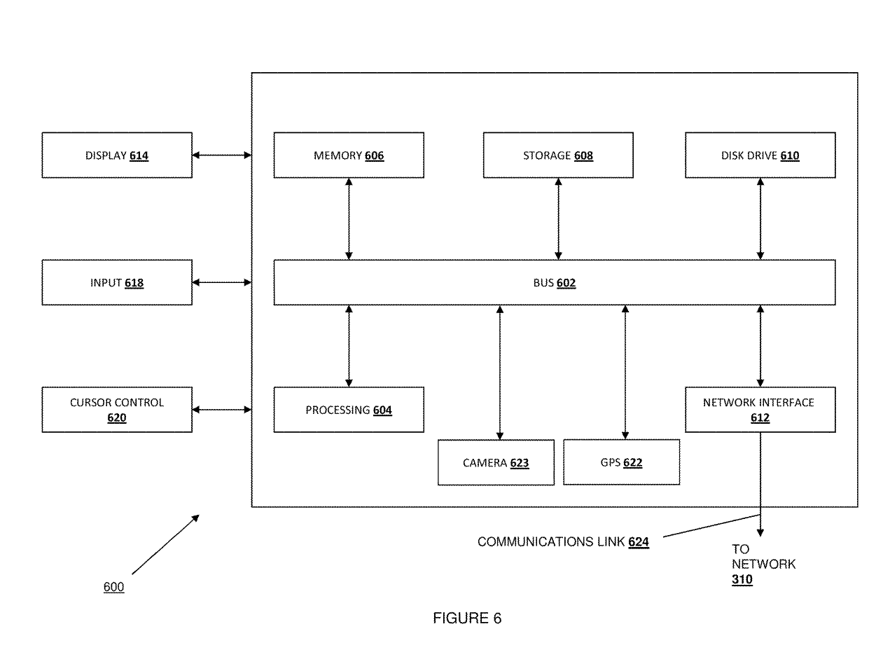

Referring now to FIG. 6, an embodiment of a computer system 600 suitable for implementing, for example, the payer device 200, the payer device 302, the payer device 400, the payer device 500, the merchant devices 304, the payment services provider device 306, the account provider device 307, and/or the system provider device 308, is illustrated. It should be appreciated that other devices utilized by payers, merchants, payment services providers, account providers, and system providers in the system discussed above may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT, LCD, touch-sensitive display device, etc.), an input component 618 (e.g., keyboard, keypad, virtual keyboard, touch-sensitive display device), a cursor control component 620 (e.g., mouse, pointer, or trackball), a location determination component 622 (e.g., a Global Positioning System (GPS) device as illustrated, a cell tower triangulation device, a Wi-Fi triangulation device, and/or a variety of other location determination devices known in the art), and/or a camera device 623. In one implementation, the disk drive component 610 may comprise a database having one or more disk drive components.

In accordance with embodiments of the present disclosure, the computer system 600 performs specific operations by the processor 604 executing one or more sequences of instructions contained in the memory component 606, such as described herein with respect to the payer devices 200, 302, 400 and 500, the merchant device(s) 304, the payment services provider device 306, the account provider device(s) 307, and/or the system provider device 308. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 600. In various other embodiments of the present disclosure, a plurality of the computer systems 600 coupled by a communication link 624 to the network 310 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

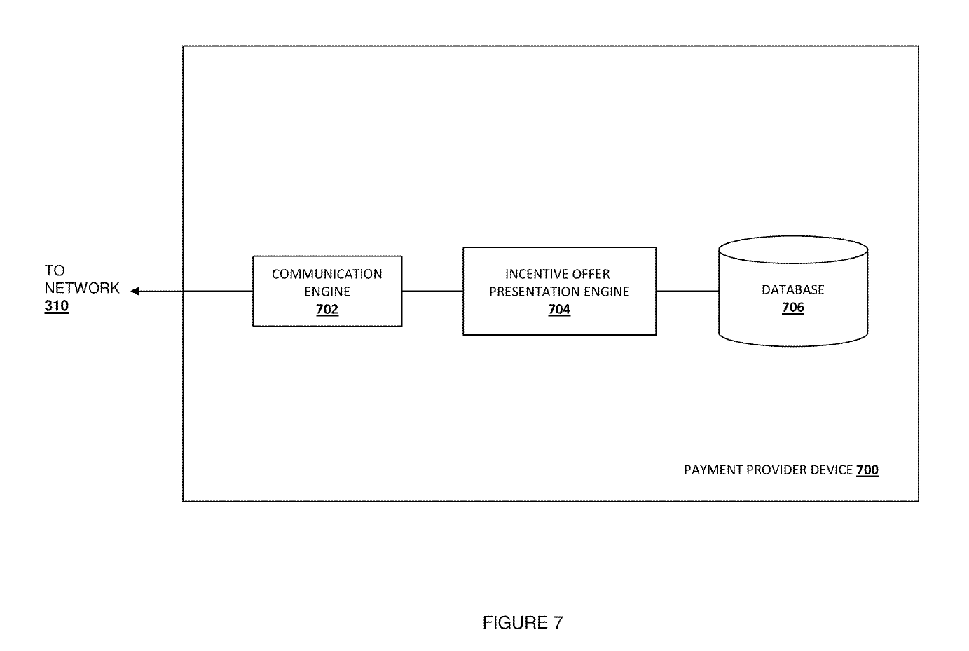

Referring now to FIG. 7, an embodiment of a payment provider device 700 is illustrated. In an embodiment, the device 700 may be the system provider device 308 discussed above. The device 700 includes a communication engine 702 that is coupled to the network 310 and to an incentive offer presentation engine 704 that is coupled to a database 706. The communication engine 702 may be software or instructions stored on a computer-readable medium that allows the device 700 to send and receive information over the network 310. The incentive offer presentation engine 704 may be software or instructions stored on a computer-readable medium that is operable to detect a location of a mobile device using a location detection sensor, display on a touch sensitive display device an incentive offer based at least on the location of the mobile device, the incentive offer being retrieved over a network from a payment services provider, detect, using the touch sensitive display device, a directional touch input from the user of the mobile device, wherein the directional touch input is one of a first swipe input towards a first direction and a second swipe input towards a second direction, the first swipe input causing the one or more hardware processors to associate the incentive offer with the user account information, and the second swipe input causing the one or more hardware processors to discard the incentive offer, receive, using the touch-sensitive display device, a request from the user to use a selected incentive offer, display, on the touch-sensitive display device, the selected incentive offer, and/or provide any of the other functionality that is discussed above. While the database 706 has been illustrated as located in the payment provider device 700, one of skill in the art will recognize that it may be connected to the incentive offer presentation engine 704 through the network 310 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile device, comprising:
a non-transitory memory storing user account information for a payment services provider;
one or more location detection sensors;
a touch-sensitive display; and
one or more hardware processors coupled to the non-transitory memory, the one or more location detection sensors, and the touch-sensitive display, wherein the one or more processors are configured to read instructions from the memory to perform the steps of:
detecting, using the one or more location detection sensors, a location of the mobile device;
displaying, on the touch-sensitive display, an incentive offer based at least on the location of the mobile device, wherein the incentive offer is retrieved over a network from the payment services provider;
detecting, using the touch-sensitive display, a directional touch input from the user of the mobile device, wherein the directional touch input is one of a first swipe input in a first direction and a second swipe input in a second direction, the first swipe input causing the one or more hardware processors to associate the incentive offer with the user account information, and the second swipe input causing the one or more hardware processors to discard the incentive offer;
receiving, using the touch-sensitive display, a request from the user to use a selected incentive offer; and
displaying, on the touch-sensitive display, the selected incentive offer.

2. The system of claim 1, wherein the incentive offer is a first incentive offer, and wherein the one or more hardware processors are configured to read instructions from the memory to perform the steps of:
displaying, on the touch-sensitive display, a second incentive offer based at least on the location of the mobile device, wherein the second incentive offer is retrieved over a network from the payment services provider and displayed following the selection of the first incentive offer.

3. The system of claim 1, wherein the directional touch input is further one of a third swipe input in a third direction, the third swipe input causing the one or more hardware processors to display, on the touch-sensitive display, a share screen, and wherein one or more processors are configured to read instructions from the memory to perform the steps of:
receiving, using the touch-sensitive display, an identifier for a second user; and
transmitting the incentive offer to the second user based on the identifier.

4. The system of claim 1, wherein the user account information stores a plurality of associated incentive offers, and wherein the displayed incentive offer is an incentive offer in the plurality of stored associated incentive offers.

5. The system of claim 1, wherein the one or more processors are configured to read instructions from the memory to perform the steps of:
transmitting, over a network and to the payment services provider, an indication that an incentive offer was associated with the user account information.

6. The system of claim 1, wherein the directional touch input is further one of a fourth swipe input in a fourth direction, the fourth swipe input causing the one or more hardware processors to display, on the touch-sensitive display, a text input area, and wherein the one or more processors are configured to read instructions from the memory to perform the steps of:
receiving, using the touch-sensitive display, a plurality of characters of text input from the user; and
associating the incentive offer and the plurality of characters of text input with the user account information.

7. The system of claim 1, wherein the one or more processors are configured to read instructions from the memory to perform the steps of:
receiving, from a user of the mobile device, a request to display one or more incentive offers.

8. A computer-implemented method for providing incentive offers to a user of a mobile device, comprising:
detecting, using one or more location detection sensors of a mobile device, a location of the mobile device;
displaying, on a touch-sensitive display of the mobile device, an incentive offer based at least on the location of the mobile device, wherein the incentive offer is retrieved over a network from the payment services provider;
detecting, using the touch-sensitive display, a directional touch input from the user of the mobile device, wherein the directional touch input is one of a first swipe input in a first direction and a second swipe input in a second direction, the first swipe input causing an association to be created between the incentive offer and user account information for the user of the mobile device, and the second swipe input causing the incentive offer to be discarded;
receiving, using the touch-sensitive display, a request from the user to use a selected incentive offer; and
displaying, on the touch-sensitive display, the selected incentive offer.

9. The method of claim 8, wherein the incentive offer is a first incentive offer, and wherein the method further comprises displaying, on the touch-sensitive display, a second incentive offer based at least on the location of the mobile device, wherein the second incentive offer is retrieved over a network from the payment services provider and displayed following the selection of the first incentive offer.

10. The method of claim 8, wherein the directional touch input is further one of a third swipe input in a third direction, the third swipe input causing a display, on the touch-sensitive display, of a share screen, and wherein the method further comprises:
receiving, using the touch-sensitive display, an identifier for a second user; and
causing the incentive offer to be transmitted to the second user based on the identifier.

11. The method of claim 8, further comprising:
storing a plurality of incentive offers associated with the user account information for the user of the mobile device, and
wherein the displayed incentive offer is an incentive offer in the plurality of stored incentive offers.

12. The method of claim 8, further comprising:
transmitting, over a network and to the payment services provider, an indication that an incentive offer was associated with the user account information.

13. The method of claim 8, wherein the directional touch input is further one of a fourth swipe input in a fourth direction, the fourth swipe input causing a display, on the touch-sensitive display, of a text input area, and wherein the method further comprises:
receiving, using the touch-sensitive display, a plurality of characters of text input from the user; and
associating the incentive offer and the plurality of characters of text input with the user account information.

14. The method of claim 8, further comprising receiving, from the user of the mobile device, a request to display one or more incentive offers.

15. A non-transitory machine-readable medium comprising a plurality of machine-readable instructions which, when executed by one or more processors, are adapted to cause the one or more processors to perform a method comprising:
detecting, using one or more location detection sensors of a mobile device, a location of the mobile device;
displaying, on a touch-sensitive display of the mobile device, an incentive offer based at least on the location of the mobile device, wherein the incentive offer is retrieved over a network from the payment services provider;
detecting, using the touch-sensitive display, a directional touch input from the user of the mobile device, wherein the directional touch input is one of a first swipe input in a first direction and a second swipe input in a second direction, the first swipe input causing an association to be created between the incentive offer and user account information for the user of the mobile device, and the second swipe input causing the incentive offer to be discarded;
receiving, using the touch-sensitive display, a request from the user to use a selected incentive offer; and
displaying, on the touch-sensitive display, the selected incentive offer.

16. The non-transitory machine-readable medium of claim 14, wherein the incentive offer is a first incentive offer, and wherein the method further comprises displaying, on the touch-sensitive display, a second incentive offer based at least on the location of the mobile device, wherein the second incentive offer is retrieved over a network from the payment services provider and displayed following the selection of the first incentive offer.

17. The non-transitory machine-readable medium of claim 14, wherein the directional touch input is further one of a third swipe input in a third direction, the third swipe input causing a display, on the touch-sensitive display, of a share screen, and wherein the method further comprises:
receiving, using the touch-sensitive display, an identifier for a second user; and
causing the incentive offer to be transmitted to the second user based on the identifier.

18. The non-transitory machine-readable medium of claim 14, wherein the method further comprises:
storing a plurality of incentive offers associated with the user account information for the user of the mobile device, and
wherein the displayed incentive offer is an incentive offer in the plurality of stored incentive offers.

19. The non-transitory machine-readable medium of claim 15, wherein the method further comprises:
transmitting, over a network and to the payment services provider, an indication that an incentive offer was associated with the user account information.

20. The non-transitory machine-readable medium of claim 15, wherein the directional touch input is further one of a fourth swipe input in a fourth direction, the fourth swipe input causing a display, on the touch-sensitive display, of a text input area, and wherein the method further comprises:
receiving, using the touch-sensitive display, a plurality of characters of text input from the user; and
associating the incentive offer and the plurality of characters of text input with the user account information.
